(19) United States
(12) Patent Application Publication
(10) Pub. No.: US 2004/0037414 A1
(43) Pub. Date: Feb. 26, 2004

(54) Network feature management

(76) Inventors: Patel Pramodkumar, Phoenix, AZ (US); Bernie R. McKibben, Gilbert, AZ (US); Derek Oxley, Chandler, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/226,990

(22) Filed: Aug. 23, 2002

(51) Int. Cl. H04M 3/00; H04M 5/00

(52) U.S. Cl. 379/265.01

(57) ABSTRACT

A business or enterprise (70) may purchase a block of telecommunication network features from a network administrator (60). A user (10) may be a mobile user or various other kinds of users connectable by wireline or wireless networks. The user has an association with the business or enterprise. The user may be an employee of the business or a purchaser of services from the enterprise. The features are implemented for use by the user through various call or session agents (50, 80). After a feature is utilized, the business or enterprise checks whether a particular feature has been exhausted (212). If the feature has been exhausted, another block of features is obtained from the network administrator.

### BACKGROUND OF THE INVENTION

The present invention pertains to telecommunication networks and more particularly to the management and assignment of network features to users.

Currently, telecommunication networks assign features of the network to specific subscribers or end users. That is, the network itself manages the features assigned to each subscriber. These features may include call forwarding, call waiting, roaming for mobile telecommunications, etc.

Typically an end user purchases or leases a feature directly from the network's operator. This means that the network must update its database information, typically home location register (HLR), to include each particular user as having or not having a particular feature active over a certain time period. Typically network operators bill on a monthly basis so a service would be active for an end user for the whole month. This may be acceptable for a home user, however, for certain end user's pattern of usage of a feature, there may be advantages to have a feature for a week or a day or a particular call/session on a wireless or wire line network.

Typically the network operator takes days to install a feature (i.e. update a database) for a particular user. That is to activate the feature so that the user may have the required call forwarding or call waiting feature. The end user cannot get instant service for a feature for a particular call or a particular day or a particular time period which is very short. Network operators are unable to provide this instant turn on or turn off for many features which the network provides.

Accordingly, it would be advantageous to have a method for supplying network features to end users on a call or session basis or on a short fixed time basis.

### BRIEF DESCRIPTION OF THE DRAWING

FIG. 1 is a block diagram of a feature management arrangement in accordance with the present invention.

FIG. 2 is a flow chart of a method for feature management in accordance with the present invention.

### DESCRIPTION OF THE PREFERRED EMBODIMENT OF THE INVENTION

Current networks assign features to specific subscribers and charge the subscriber for each feature accordingly. In the present invention, a business or an enterprise may purchase a set or block of features from a network operator separate from individual subscription identities and/or associated air-time (or blocks of data for data services). The business or enterprise may then allocate these features to its own employees or subscribers on an as needed basis Once the allocated features have been utilized, the business or enterprise may order or purchase or lease a new block of features from a network operator. This feature subscription may be independent of air-time purchased for the subscriber's service provider. Further, air-time can optionally be purchased from other network operators (generating potential savings when roaming outside the subscriber's own service providers network.

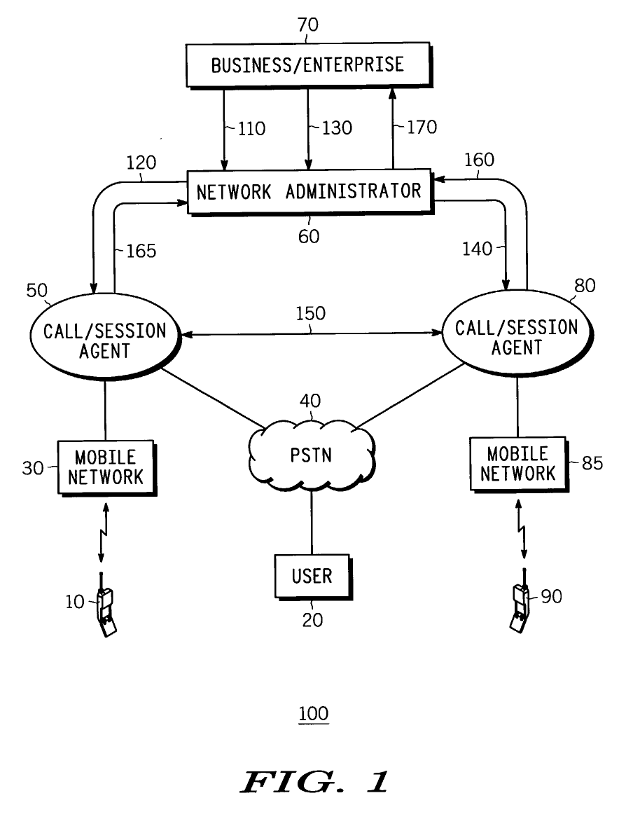

Referring to FIG. 1, a block diagram of an arrangement for network feature management is shown.

A business or enterprise 70 can purchase a feature or a set or block of various features from a network operator 60. For example, a corporation or hotel 70 may purchase a special feature or block of features from a network operator 60. The corporation or hotel for example, may then allocate these features among its employees or guests and charge the guests accordingly. The corporation or business may purchase these features at wholesale prices and retail them to guests or incur the savings of purchasing wholesale large blocks of features for employees of a corporation.

Mobile user 10 has an appearance within mobile network 30. Mobile network 30 may be a network in which mobile user 10 has roamed.

Business or enterprise 70 requests a feature or block of features and optionally the appropriate air-time for mobile user 10, for example. One feature will be given to mobile user 10 and the corresponding air-time. Next, network operator's network administrator 60 activates the features and appropriate air-time or bandwidth usage for mobile user 10 through the call or session agent 50 associated with mobile user 10. This process is depicted by message transfer 120.

Features which may be managed by this methodology include, but are not limited to: call waiting, call forwarding, three-way calling, secure video conferencing, secure data transfer, temporary closed user group admission, and a higher quality of service privileges for a specific time period or a particular session.

Next, the business or enterprise 70 requests features or a feature for mobile user 90 and also optionally the corresponding air-time. This is represented by message transfer 130. Network administrator 60 then activates the feature and the air-time or packet usage for mobile user 90 as represented by message transfer 140. This is accomplished by network administrator 60 sending message transfer 140 to call or session agent 80 which handles mobile user 90. Mobile user 90 may be a roaming user. Mobile user 90 connects through mobile network 85 to call or session agent 80. The feature is thereby enabled for mobile user 90 through call or session agent 80 and mobile network 85.

Call or session agents 50 and 80 then establish a connection from mobile subscriber 10 through mobile network 30 and agent 50 via path 150 to session agent 80 through mobile network 85 to mobile user 90.

Alternately the call or session agents 50 and 80 may establish the call through the public switch telephone network (PSTN) 40. Further user 20 may be one of the parties for the call or session. For example, the current session might be a three-way call in which user 20 who appears only through the PSTN is connected to call or session agents 50 and 80.

Once the call or session between mobile users 10 and 90 and possibly user 20 has been completed, call or session agent 80 reports back on the feature and the time duration or packet usage for its use via message 160 to network operator 60. Similarly, call or session agent 50 transmits the feature allocation and time or packet usage when the call or session is complete to network operator 60 via message 165.

Lastly, a feature usage report and charge report 170 is transmitted from network operator 60 to the business or enterprise 70 for its accounting and tracking purposes. This feature usage in the present example will show a feature usage for mobile subscriber 10 and 90 including feature identification and air-time or packet usage.

Although the above example depicted a mobile subscriber to mobile subscriber connection with a PSTN user being added for a three-way call example, the primary users of the feature management arrangement may be fixed line users such as PSTN subscriber 20. This feature management arrangement equally applies to both wired and wireless users.

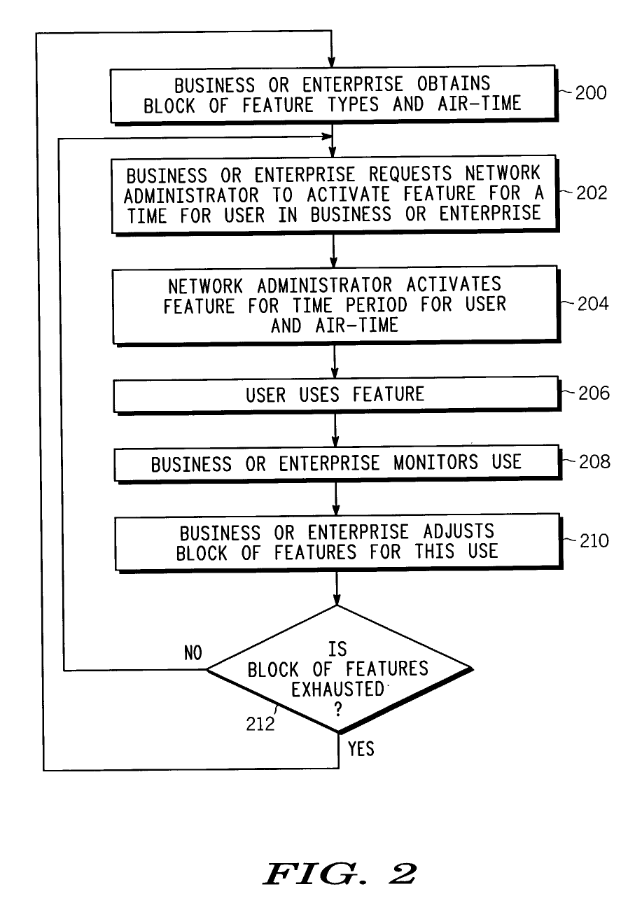

Referring to FIG. 2, a flow chart of the feature management method in accordance with the preset invention is shown.

At block 200 the business or enterprise obtains a block of features and optionally corresponding air times. For example, a business may purchase or lease a block of 100 features. This block of 100 features may include 75 call forwarding features and 25 video conference features. The business would be purchasing the block of features at a discount; and, if it is an internal corporation of users would save money by such wholesale purchase. If the business is a retail business such as a hotel, it could generate revenue by selling the features retail to various guests and users.

Next, in block 202 the business or enterprise requests the network administrator to activate the particular feature for a time period for a user having an association with the business or enterprise. The network administrator responds by activating the feature for the time period for the particular user and supplying the associated air-time or packet usage, block 204. The user then uses the particular feature for a particular time period or packet count, block 206.

Through the network operator 60, the business or enterprise 70 monitors the user's usage of the feature, block 208. In block 210, the business or enterprise incurs any potential savings by adjusting the number of unused features in the block as a result of the previous use.

Next, the business or enterprise determines whether the block of features is exhausted, block 212. If the block of features is exhausted, block 212 transfers control via the YES path to block 200 which obtains another block of features and corresponding air-time. If the block of features is not exhausted, block 212 transfers control via the NO path to block 202 for requesting the network administrator 60 to activate features for another user having an association with the business or enterprise. The process is then ended.

Referring again to FIG.1 in an alternate embodiment, the user 10 and the business or enterprise 70 may be one in the same entity. In this embodiment, the acquisition of services 110 is accomplished directly by user 10. Similarly, the monitoring and reporting of the feature usage will be from network operator 60 to user 10.

The feature management method described herein provides the ability for a business to purchase blocks of features and time utilization of the system and re-distribute these features to subscriber associates of that business without interfacing with the network operator on a per usage basis. In addition, it provides businesses with the ability to purchase features wholesale and resell them to users at retail prices and thereby generate a profit.

Any user with proxy capability within a network (e.g., mobile subscribers, mobile roamer, a PSTN user or a voice-over internet protocol for 3G mobile) can receive features from a business or enterprise. This provides maximum flexibility for feature management and reuse.

Although the preferred embodiment of the invention has been illustrated, and that form described in detail, it will be readily apparent to those skilled in the art that various modifications may be made therein without departing from the spirit of the present invention or from the scope of the appended claims.

1. A non-network feature management method comprising the steps of:
obtaining, by a non-network operator, at least one feature;
associating a user of the at least one feature with the non-network operator;
using, by the user, the at least one feature; and
monitoring, by the non-network operator, usage of the at least one feature by the user.

2. A non-network feature management method as claimed in claim 1, wherein the step of obtaining includes the step of obtaining a block of features by the non-network operator from a network administrator.

3. A non-network feature management method as claimed in claim 1, wherein the step of obtaining further includes at least one of the steps of: purchasing, leasing, licensing, buying or otherwise acquiring by the non-network operator the at least one feature from a network administrator.

4. A non-network feature management method as claimed in claim 1, wherein the step of associating includes the step of authorizing by the non-network operator the user to use the at least one feature via an agent.

5. A non-network feature management method as claimed in claim 4, wherein the step of using includes the step of enabling a user through a corresponding network by the agent to use the at least one feature with at least one other user.

6. A non-network feature management method as claimed in claim 4, wherein the step of monitoring includes the step of indicating by the agent a completion of usage of the at least one feature or an associated air-time or packet usage of use to a network administrator.

7. A non-network feature management method as claimed in claim 6, wherein the step of monitoring further includes the step of reporting the usage of the at least one feature to the non-network operator by the network administrator.

8. A non-network feature management method as claimed in claim 7, wherein the step of monitoring further includes the steps of:
the at least one feature including a plurality of various features; and
the non-network operator adjusts the plurality of various features for the usage of the at least one feature by the user.

9. A non-network feature management method as claimed in claim 8, wherein there is further included a step of determining by the non-network operator whether the plurality of various features has been exhausted.

10. A non-network feature management method as claimed in claim 9, wherein if the plurality of various features has been exhausted, there is further included a step of obtaining by the non-network operator another plurality of various features from the network administrator.

11. A non-network feature management method as claimed in claim 9, wherein if the plurality of various features has not been exhausted, there is further included a step of authorizing the usage of the at least one other feature of the plurality of various features for another user.

12. A non-network feature management method as claimed in claim 1, wherein the user comprises a mobile user.

13. A non-network feature management method as claimed in claim 1, wherein the user comprises a wireline public switch telephone network user.

14. A non-network feature management method as claimed in claim 1, wherein the user comprises a voice-over internet protocol 3G (third generation) mobile user.

15. A non-network feature management method as claimed in claim 1, wherein the user comprises a voice-over internet protocol wireline user.

16. A user controlled feature management method comprising the steps of:
obtaining by a user a block of network supplied features or air-time, bandwidth or packet usage;
using by the user at least one feature of the block of network supplied features or air-time, bandwidth or packet usage; and
monitoring by the user the block of network supplied features or air-time, bandwidth or packet usage.

17. The user controlled feature management method as claimed in claim 16, wherein the step of monitoring includes the steps of:
determining by the user a completion of a usage of the at least one feature; and
adjusting by the user a number of features of the block of network supplied features existing after the completion of the at least one feature.

18. The user controlled feature management method as claimed in claim 17, wherein after the step of adjusting there is further included steps of:
if the block of network supplied features has been exhausted, obtaining by the user another block of network supplied features or air-time, bandwidth or packet usage; and
if the block of network supplied features has not been exhausted, continuing by the user with using at least one feature of the block of network supplied features.

19. The user controlled feature management method as claimed in claim 17, wherein after the step of adjusting there is further included the steps of:
if the block of network supplied features has been exhausted, obtaining by the user another block of network supplied features or air-time, bandwidth or packet usage; and
if the block of network supplied features has not been exhausted, continuing by the user with using at least one feature of the block of network supplied features.

20. The user controlled feature management method as claimed in claim 16, wherein there is further included a step of providing the block of network supplied features, said block of network supplied features including at least one of:
call forwarding, call waiting, three-way calling, video conferencing, secure data transferring,.secure video conferencing, temporary closed user group admission and higher quality of service for a particular time period.

21. The user controlled feature management method as claimed in claim 16, wherein there is further included a step of providing the user, the user including at least one of: a mobile user, a wireless user, a wire line PSTN (public switched telephone network) user, a voice-over internet protocol 3G (third generation) mobile user, and a voice-over internet protocol wire line user.
